(19) United States
(12) Patent Application Publication
(10) Pub. No.: US 2025/0378091 A1
(43) Pub. Date: Dec. 11, 2025

(54) INFORMATION PROCESSING APPARATUS, AND INFORMATION PROCESSING METHOD

(71) Applicant: NEC Corporation, Tokyo (JP)

(72) Inventors: Masafumi ENOMOTO, Tokyo (JP); Kosuke AKIMOTO, Tokyo (JP); Kunihiro TAKEOKA, Tokyo (JP); Masafumi OYAMADA, Tokyo (JP)

(73) Assignee: NEC Corporation, Tokyo (JP)

(21) Appl. No.: 19/228,963

(22) Filed: Jun. 5, 2025

(30) Foreign Application Priority Data
Jun. 10, 2024 (JP) 2024-093833

(51) Int. Cl. G06F 16/332; G06F 16/334

(52) U.S. Cl. CPC G06F 16/3325; G06F 16/3344

(57) ABSTRACT

An object of the present disclosure is to provide a technology capable of improving quality of a finally generated response in retrieval-augmented generation and supporting decision making. An information processing apparatus includes: a first acquisition unit configured to acquire a query; a first retrieval unit configured to retrieve an initial passage related to the query from a passage set including a plurality of passages; a second retrieval unit configured to retrieve an additional passage from the passage set with reference to association information including a strength of association between the passages included in the passage set, and the initial passage; and a third retrieval unit configured to perform retrieval processing using the initial passage and the additional passage.

### INCORPORATION BY REFERENCE

This application is based upon and claims the benefit of priority from Japanese patent application No. 2024-093833, filed on Jun. 10, 2024, the disclosure of which is incorporated herein in its entirety by reference.

### TECHNICAL FIELD

The present disclosure relates to an information processing apparatus, an information processing method, and a program.

### BACKGROUND ART

In recent years, machine-learned language models have been utilized in retrieval processing, generation processing, and the like. As an example, “Reliable, Adaptable, and Attributable Language Models with Retrieval”, A. Asai et al., 2024/3, https://arxiv.org/abs/2403.03187 discloses a technology relating to retrieval-augmented generation (RAG).

### SUMMARY

In retrieval-augmented generation (RAG), a text group is usually retrieved for an input question or the like using a language model, and generation processing is performed with reference to the retrieved text group. In such retrieval-augmented generation according to the related art, the retrieved text group is often not self-contained by itself, and as a result, there is a problem that quality of a finally generated response is not favorable.

The present disclosure has been made in view of the above problems, and an example object of the present disclosure is to provide an information processing apparatus, an information processing method, and a program capable of improving quality of a finally generated response in retrieval-augmented generation.

An information processing apparatus according to a first example aspect of the present disclosure includes: first acquisition unit for acquiring a query; first retrieval unit for retrieving an initial passage related to the query from a passage set including a plurality of passages; second retrieval unit for retrieving an additional passage from the passage set with reference to association information including a strength of association between the passages included in the passage set, and the initial passage; and third retrieval unit for performing retrieval processing using the initial passage and the additional passage.

An information processing apparatus according to a second example aspect of the present disclosure includes: acquisition unit for acquiring input data including a sentence group; generation unit for generating a passage set including a plurality of passages included in the sentence group; calculation unit for calculating, by using a language model, association information which includes a strength of association between the plurality of passages included in the passage set and is referred to in retrieval processing; and storage unit for storing the association information in association with the plurality of passages.

An information processing method according to a third example aspect of the present disclosure includes: acquiring a query; retrieving an initial passage related to the query from a passage set including a plurality of passages; retrieving an additional passage from the passage set with reference to association information including a strength of association between the passages included in the passage set, and the initial passage; and performing retrieval processing using the initial passage and the additional passage.

An information processing method according to a fourth example aspect of the present disclosure includes: acquiring input data including a sentence group; generating a passage set including a plurality of passages included in the sentence group; calculating, by using a language model, association information which includes a strength of association between the plurality of passages included in the passage set and is referred to in retrieval processing; and storing the association information in association with the plurality of passages.

A program according to a fifth example aspect of the present disclosure is a program for causing a computer to function as an information processing apparatus and to perform: first acquisition processing of acquiring a query; first retrieval processing of retrieving an initial passage related to the query from a passage set including a plurality of passages; second retrieval processing of retrieving an additional passage from the passage set with reference to association information including a strength of association between the passages included in the passage set, and the initial passage; and retrieval processing using the initial passage and the additional passage.

A program according to a sixth example aspect of the present disclosure is a program for causing a computer to function as an information processing apparatus and to perform: acquisition processing of acquiring input data including a sentence group; generation processing of generating a passage set including a plurality of passages included in the sentence group; calculation processing of calculating, by using a language model, association information which includes a strength of association between the plurality of passages included in the passage set and is referred to in retrieval processing; and storage processing of storing the association information in association with the plurality of passages.

According to an example aspect of the present disclosure, there is an exemplary effect that it is possible to provide a technology capable of improving quality of a finally generated response in retrieval-augmented generation.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a flowchart illustrating a flow of an information processing method according to the present disclosure;

FIG. 7 is a diagram for describing information processing according to the present disclosure;

FIG. 8 is a diagram for describing information processing according to the present disclosure;

FIG. 9 is a flowchart illustrating a flow of an information processing method according to the present disclosure;

FIG. 10 is a diagram for describing information processing according to the present disclosure;

FIG. 11 is a diagram for describing information processing according to the present disclosure;

FIG. 12 is a diagram for describing information processing according to the present disclosure;

FIG. 13 is a diagram for describing information processing according to the present disclosure;

FIG. 14 is a diagram for describing information processing according to the present disclosure;

FIG. 15 is a diagram for describing information processing according to the present disclosure;

FIG. 16 is a diagram for describing information processing according to the present disclosure; and

FIG. 17 is a block diagram illustrating a configuration of a computer that functions as an information processing apparatus according to the present disclosure.

### EXAMPLE EMBODIMENT

Hereinafter, example embodiments of the present disclosure will be exemplified. However, the present disclosure is not limited to the example embodiments described below, and various modifications can be made within the scope described in the claims. For example, example embodiments obtained by appropriately combining the technologies (some or all of the products or methods) adopted in the following example embodiments can also fall within the scope of the present disclosure. In addition, example embodiments obtained by appropriately omitting some of the technologies adopted in the following example embodiments can also fall within the scope of the present disclosure. In addition, the effects mentioned in the following example embodiments are examples of effects expected in the example embodiments, and do not define the extension of the present disclosure. That is, example embodiments that do not achieve the effects mentioned in the following example embodiments can also fall within the scope of the present disclosure.

### First Example Embodiment

A first example embodiment that is an example of an example embodiment of the present disclosure will be described in detail with reference to the drawings. The present example embodiment is a basic form of each example embodiment described below. Note that an application range of each technology adopted in the present example embodiment is not limited to the present example embodiment. That is, each technology adopted in the present example embodiment can also be adopted in other example embodiments included in the present disclosure as long as no particular technical problem occurs. In addition, each technology illustrated in the drawings referred to for describing the present example embodiment can also be adopted in other example embodiments included in the present disclosure as long as no particular technical problem occurs.

### (Configuration of Information Processing Apparatus 1)

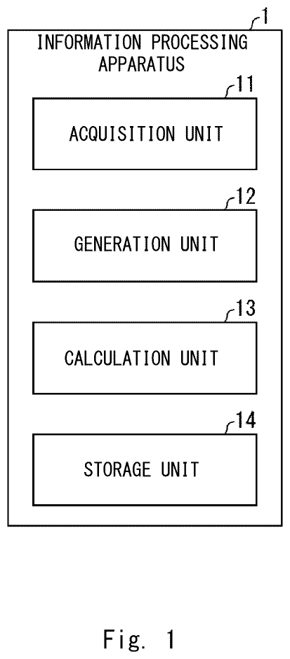

A configuration of an information processing apparatus 1 according to the present example embodiment will be described with reference to FIG. 1. FIG. 1 is a block diagram illustrating a configuration of the information processing apparatus 1. As illustrated in FIG. 1, the information processing apparatus 1 includes an acquisition unit 11, a generation unit 12, a calculation unit 13, and a storage unit 14. As an example, the information processing apparatus 1 is configured to calculate association information referred to in retrieval processing performed in an information processing apparatus 2 described below in advance by using a language model, and store the association information.

### (Acquisition Unit 11)

The acquisition unit 11 acquires input data including a sentence group. Here, the sentence group includes, as an example, one or a plurality of documents including a plurality of sentences described in a natural language, and the present example embodiment is not limited thereto. Furthermore, the language of the sentence group is not particularly limited.

### (Generation Unit 12)

The generation unit 12 generates a passage set including a plurality of passages included in the sentence group. As an example, the generation unit 12 performs processing of extracting the plurality of passages from the sentence group and including, in the passage set, the plurality of extracted passages. Here, the passage may be a unit such as a paragraph, a sentence, a phrase, a word, or a morpheme included in the sentence group, or may be another unit. As an example, the passage may be a group of a predetermined number of characters extracted from the sentence group.

### (Calculation Unit 13)

The calculation unit 13 calculates, by using the language model, the association information which includes a strength of association between the plurality of passages included in the passage set and is referred to in the retrieval processing. Here, a specific example of the calculation of the association information using the language model does not limit the present example embodiment.

As an example, processing of:
acquiring a similar passage p_{b} similar to a certain passage pₐ for the passage pₐ by using an embedding model; and
computing a generation probability LM (pₐ|p_{b}) of the passage pₐ by the language model in a case where the similar passage p_{b} is given, and setting the generation probability as a score s_{ab} indicating a strength of association between the passages pₐ and p_{b} may be performed, or
processing of
setting cosine similarity between the certain passage pₐ and the similar passage p_{b} as the score s_{ab} indicating the strength of association between the passage pₐ and the similar passage p_{b} may be performed. As an example, in a case where passages p₁, p₂, and p₃ are included in the passage set, the calculation unit 13 may perform processing of:
calculating a score indicating a strength of association defined for each passage pair for a plurality of passage pairs like
a score s₁₂ indicating a strength of association between the passages p₁ and p₂,
a score s₂₃ indicating a strength of association between the passage p₂ and p₃, and
a score s₃₁ indicating a strength of association between the passage p₃ and p₁, and
including, in the association information, the calculated score.

### (Storage Unit 14)

The storage unit 14 stores the association information in association with the plurality of passages. As an example, the storage unit 14 stores the association information in a storage device (not illustrated). The stored association information is referred to in the retrieval processing described above as an example. The storage unit 14 may be expressed as a storage control unit.

### (Effects of Information Processing Apparatus 1)

As described above, the information processing apparatus 1 adopts a configuration in which
input data including a sentence group is acquired,
a passage set including a plurality of passages included in the sentence group is generated,
association information which includes a strength of association between the plurality of passages included in the passage set and is referred to in the retrieval processing is calculated by using a language model, and
the association information is stored in association with the plurality of passages. As described above, the information processing apparatus 1 performs processing of calculating and storing the association information to be referred to in the retrieval processing by using the language model. Therefore, in the retrieval processing, it is not necessary to calculate the association information again using the language model. Therefore, with the above configuration, a processing speed in the retrieval processing increases, and user convenience is improved. Furthermore, with the above configuration, the association information can be used in the retrieval processing, and thus, self-containedness of information is improved, and as a result, quality of a finally generated response is improved.

### (Flow of Information Processing Method S1)

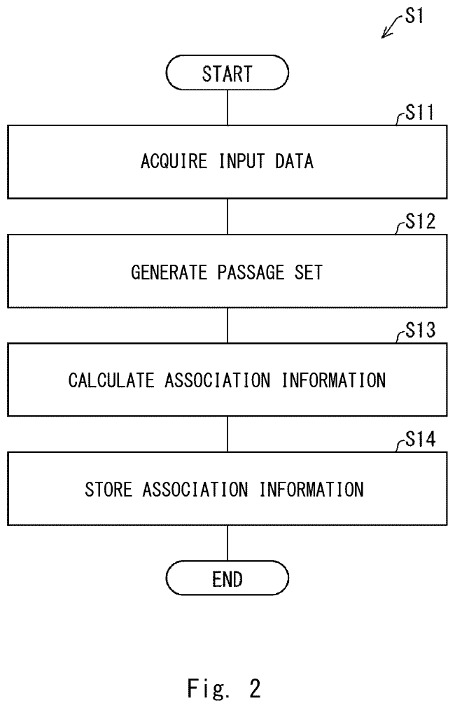

Next, a flow of an information processing method S1 according to the present example embodiment will be described with reference to FIG. 2. FIG. 2 is a flowchart illustrating a flow of the information processing method S1. As illustrated in FIG. 2, the information processing method S1 includes a step (processing) S11 of acquiring input data, a step (processing) S12 of generating a passage set, a step (processing) S13 of calculating association information, and a step (processing) S14 of storing the association information.

### (Step S11)

In step S11, the acquisition unit 11 acquires the input data including the sentence group. Since the specific processing performed by the acquisition unit 11 has been described above, the description thereof will be omitted here.

### (Step S12)

In step S12, the generation unit 12 generates the passage set including the plurality of passages included in the sentence group. Since the specific processing performed by the generation unit 12 has been described above, the description thereof will be omitted here.

### (Step S13)

In step S13, the calculation unit 13 calculates the association information which includes a strength of association between the plurality of passages included in the passage set and is referred to in the retrieval processing, by using the language model. Since the specific processing performed by the calculation unit 13 has been described above, the description thereof will be omitted here.

### (Step S14)

In step S14, the storage unit 14 stores the association information in association with the plurality of passages. Since the specific processing performed by the storage unit 14 has been described above, the description thereof will be omitted here.

### (Effects of Information Processing Method S1)

As described above, the information processing method S1 adopts a configuration in which
input data including a sentence group is acquired,
a passage set including a plurality of passages included in the sentence group is generated,
association information which includes a strength of association between the plurality of passages included in the passage set and is referred to in the retrieval processing is calculated by using a language model, and
the association information is stored in association with the plurality of passages. With the above configuration, effects similar to those of the information processing apparatus 1 are obtained.

### (Configuration of Information Processing Apparatus 2)

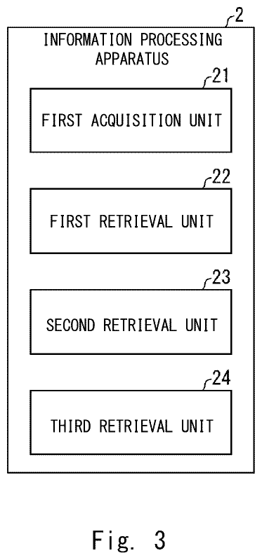

A configuration of the information processing apparatus 2 according to the present example embodiment will be described with reference to FIG. 3. FIG. 3 is a block diagram illustrating a configuration of the information processing apparatus 2. As illustrated in FIG. 3, the information processing apparatus 2 includes a first acquisition unit 21, a first retrieval unit 22, a second retrieval unit 23, and a third retrieval unit 24. As an example, the information processing apparatus 2 is configured to perform the retrieval processing with reference to the association information calculated by the information processing apparatus 1 described above.

### (First Acquisition Unit 21)

The first acquisition unit 21 acquires a query. Here, the query is described in a natural language as an example, but the present example embodiment is not limited thereto. Furthermore, the language of the query is not particularly limited.

### (First Retrieval Unit 22)

The first retrieval unit 22 retrieves an initial passage related to the query from a passage set including a plurality of passages. Here, as an example, such a passage set can be the passage set generated by the generation unit 12 included in the information processing apparatus 1 described above, but the present example embodiment is not limited thereto. The term “initial passage” is merely used for convenience of description of processing, and the present example embodiment is not limited by the term. The “initial passage” may be expressed as a “first passage”, a “first type of passage”, or the like.

### (Second Retrieval Unit 23)

The second retrieval unit 23 retrieves an additional passage from the passage set with reference to association information including a strength of association between the passages included in the passage set, and the initial passage. Here, as an example, association information calculated in advance using a language model may be used as the association information. More specifically, as an example, the association information calculated by the calculation unit 13 included in the information processing apparatus 1 described above may be used as the association information. The term “additional passage” is merely used for convenience of description of processing, and the present example embodiment is not limited by the term. The “additional passage” may be expressed as a “second passage”, a “second type of passage”, or the like.

### (Third Retrieval Unit 24)

The third retrieval unit 24 performs the retrieval processing using the initial passage and the additional passage. As an example, the third retrieval unit 24 may perform the retrieval processing by generating a prompt including the initial passage and the additional passage and inputting the prompt to the language model or a generation model. A retrieval result of the third retrieval unit 24 is presented to a user through presentation (not illustrated) or the like as an example. The retrieval processing may be referred to as generation processing.

### (Effects of Information Processing Apparatus 2)

As described above, the information processing apparatus 2 adopts a configuration in which
a query is acquired,
an initial passage related to the query is retrieved from a passage set including a plurality of passages (first retrieval processing),
an additional passage is retrieved from the passage set with reference to association information including a strength of association between the passages included in the passage set, and the initial passage (second retrieval processing), and
retrieval processing (third retrieval processing) using the initial passage and the additional passage is performed. As described above, in the information processing apparatus 2, the additional passage is retrieved from the passage set with reference to the association information including the strength of association between the passages included in the passage set, and the initial passage, and the retrieval processing is performed using the initial passage and the additional passage. Therefore, self-containedness of information used in the third retrieval processing is improved, and as a result, quality of a finally generated response (a result of the third retrieval processing) is improved. Furthermore, with the above configuration, the association information referred to in the retrieval processing may be calculated in advance using the language model and stored. Therefore, in the retrieval processing, it is not necessary to calculate the association information again using the language model. Therefore, with the above configuration, a processing speed in the retrieval processing increases, and user convenience is improved.

### (Flow of Information Processing Method S2)

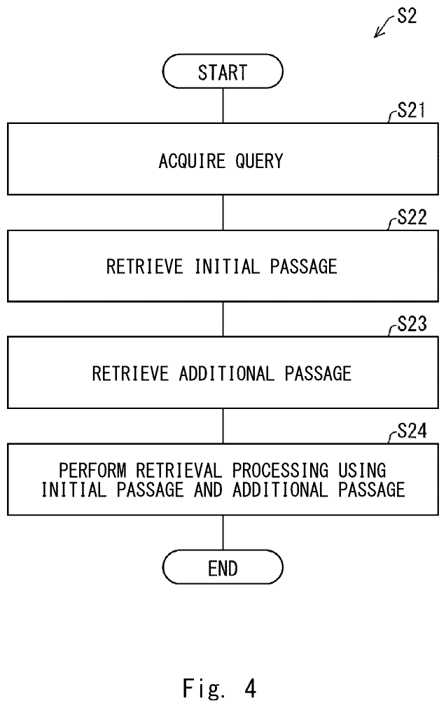

Next, a flow of the information processing method S2 according to the present example embodiment will be described with reference to FIG. 4. FIG. 4 is a flowchart illustrating a flow of the information processing method S2. As illustrated in FIG. 4, the information processing method S2 includes a step (processing) S21 of acquiring a query, a step (processing) S22 of retrieving an initial passage, a step (processing) S23 of retrieving an additional passage, and a step (processing) S24 of performing retrieval processing using the initial passage and the additional passage.

### (Step S21)

In step S21, the first acquisition unit 21 acquires the query. Since the specific processing performed by the first acquisition unit 21 has been described above, the description thereof will be omitted here.

### (Step S22)

In step S22, the first retrieval unit 22 retrieves the initial passage related to the query from the passage set including the plurality of passages. Since the specific processing performed by the first retrieval unit 22 has been described above, the description thereof will be omitted here.

### (Step S23)

In step S23, the second retrieval unit 23 retrieves the additional passage from the passage set with reference to association information including a strength of association between the passages included in the passage set, and the initial passage. Since the specific processing performed by the second retrieval unit 23 has been described above, the description thereof will be omitted here.

### (Step S24)

In step S24, the third retrieval unit 24 performs the retrieval processing using the initial passage and the additional passage. Since the specific processing performed by the third retrieval unit 24 has been described above, the description thereof will be omitted here.

### (Effects of Information Processing Method S2)

As described above, the information processing method S2 adopts a configuration in which
a query is acquired,
an initial passage related to the query is retrieved from a passage set including a plurality of passages (first retrieval processing),
an additional passage is retrieved from the passage set with reference to association information including a strength of association between the passages included in the passage set, and the initial passage (second retrieval processing), and
retrieval processing (third retrieval processing) using the initial passage and the additional passage is performed. With the above configuration, effects similar to those of the information processing apparatus 2 are obtained.

### Second Example Embodiment

A second example embodiment that is an example of an example embodiment of the present disclosure will be described in detail with reference to the drawings. Components having the same functions as the components described in the above-described example embodiment are denoted by the same reference numerals, and the description thereof will be appropriately omitted. Note that an application range of each technology adopted in the present example embodiment is not limited to the present example embodiment. That is, each technology adopted in the present example embodiment can also be adopted in other example embodiments included in the present disclosure as long as no particular technical problem occurs. Furthermore, each technology illustrated in each drawing referred to for describing the present example embodiment can also be adopted in other example embodiments included in the present disclosure as long as no particular technical problem occurs.

### (Configuration of Information Processing System 1A)

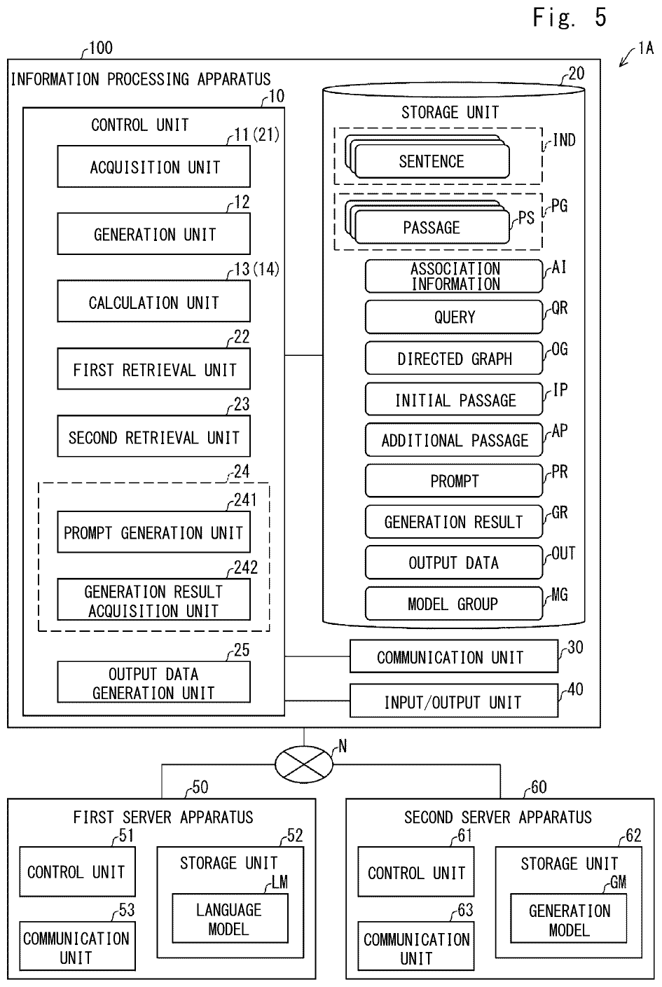

Next, a configuration of an information processing system 1A according to the present example embodiment will be described with reference to FIG. 5. FIG. 5 is a block diagram illustrating a configuration of the information processing system 1A. As illustrated in FIG. 5, the information processing system 1A includes an information processing apparatus 100, and a first server apparatus 50 and a second server apparatus 60 connected to the information processing apparatus 100 via a network N. Here, a specific configuration of the network N does not limit the present example embodiment. As an example, a wireless local area network (LAN), a wired LAN, a wide area network (WAN), a public line network, a mobile data communication network, or a combination of these networks can be used.

### (First Server Apparatus 50)

As illustrated in FIG. 5, the first server apparatus 50 includes a control unit 51, a storage unit 52, and a communication unit 53. The communication unit 53 communicates with an apparatus outside the first server apparatus 50. As an example, the communication unit 53 communicates with the information processing apparatus 100 included in the information processing system 1A. The communication unit 53 transmits data supplied from the control unit 51 to the information processing apparatus 100, and supplies data received from the information processing apparatus 100 to the control unit 51.

The storage unit 52 stores a language model LM. As an example, the storage unit 52 stores a plurality of parameters defining the language model LM. As an example, the parameters are parameters learned in advance by machine learning (parameters subjected to update processing by machine learning), but the present example embodiment is not limited thereto.

The control unit 51 acquires an output result of the language model LM by using the language model LM. As an example, the control unit 51 inputs data received from the information processing apparatus 100 to the language model LM, and acquires an output result of the language model LM. Furthermore, the output result is provided to the information processing apparatus 100 via the communication unit 53. Specific processing performed by the language model LM is described below.

### (Second Server Apparatus 60)

As illustrated in FIG. 5, the second server apparatus 60 includes a control unit 61, a storage unit 62, and a communication unit 63. The communication unit 63 communicates with an apparatus outside the second server apparatus 60. As an example, the communication unit 63 communicates with the information processing apparatus 100 included in the information processing system 1A. The communication unit 63 transmits data supplied from the control unit 61 to the information processing apparatus 100, and supplies data received from the information processing apparatus 100 to the control unit 61. The data received by the communication unit 63 from the information processing apparatus 100 can include a prompt generated by the information processing apparatus 100. Furthermore, the data provided by the communication unit 53 to the information processing apparatus 100 can include a generation result generated by a generation model GM described below based on the prompt.

The generation model GM is stored in the storage unit 62. As an example, the storage unit 62 stores a plurality of parameters defining the generation model GM. As an example, the parameters are parameters learned in advance by machine learning (parameters subjected to update processing by machine learning), but the present example embodiment is not limited thereto. A machine-learned large-scale language model can be used as the generation model GM, but the present example embodiment is not limited thereto.

The control unit 61 acquires information generated by the generation model GM by using the generation model GM. As an example, the control unit 61 acquires the generation result generated by the generation model GM based on the prompt received from the information processing apparatus 100. Furthermore, the generation result is provided to the information processing apparatus 100 via the communication unit 63. Specific processing performed by the generation model GM is described below.

In the present example embodiment, the first server apparatus 50 and the second server apparatus 60 are illustrated as apparatuses separate from the information processing apparatus 100, but the present example embodiment is not limited thereto. A control unit of the information processing apparatus 100 may function as the control unit 51 included in the first server apparatus 50 or a language model execution unit in the control unit 51. Furthermore, the control unit of the information processing apparatus 100 may function as the control unit 61 included in the second server apparatus 60 or a generation model execution unit in the control unit 61. Similarly, the language model LM stored in the storage unit 52 included in the first server apparatus 50 may be stored in a storage unit of the information processing apparatus 100, and the language model LM may be executable by the information processing apparatus 100 itself. Furthermore, the generation model GM stored in the storage unit 62 included in the second server apparatus 60 may be stored in the storage unit of the information processing apparatus 100, and the generation model GM may be executable by the information processing apparatus 100 itself.

Furthermore, in the above example, the language model LM and the generation model GM have been described as separate models, but the present example embodiment is not limited thereto. The language model LM and the generation model GM may be implemented by one machine-learned model.

### (Configuration of Information Processing Apparatus 100)

Next, a configuration of the information processing apparatus 100 according to the present example embodiment will be described with reference to FIG. 5. As illustrated in FIG. 5, the information processing apparatus 100 includes a control unit 10, a storage unit 20, a communication unit 30, and an input/output unit 40.

### (Communication Unit 30)

The communication unit 30 communicates with an apparatus outside the information processing apparatus 100. As an example, the communication unit 30 communicates with the first server apparatus 50 and the second server apparatus 60. The communication unit 30 transmits data supplied from the control unit 10 to the first server apparatus 50 and the second server apparatus 60, and supplies data received from the first server apparatus 50 and the second server apparatus 60 to the control unit 10.

### (Input/Output Unit 40)

The input/output unit 40 includes at least one of input/output apparatuses such as a keyboard, a mouse, a display, a printer, and a touch panel. Alternatively, input/output devices such as a keyboard, a mouse, a display, a printer, and a touch panel may be connected to the input/output unit 40. With such a configuration, the input/output unit 40 receives inputs of various types of information to the information processing apparatus 100 from the connected input device. In addition, the input/output unit 40 outputs various types of information to the connected output device under the control of the control unit 10. Examples of the input/output unit 40 include an interface such as a universal serial bus (USB).

### (Storage Unit 20)

The storage unit 20 stores various types of data to be referred to by the control unit 10 and various types of data generated by the control unit 10. As an example, the storage unit 20 stores
a sentence group IND,
a passage set PG,
association information AI,
a query QR,
a directed graph OG,
an initial passage IP,
an additional passage AP,
a prompt PR,
a generation result GR,
output data OUT,
a model group MG,
and the like. Since a specific example of each data is described below, the description thereof will be omitted here.

### (Control Unit 10)

As illustrated in FIG. 5, the control unit 10 includes an acquisition unit 11, a generation unit 12, a calculation unit 13, a first retrieval unit 22, a second retrieval unit 23, a third retrieval unit 24, and an output data generation unit 25. Here, since the acquisition unit 11 functions as the acquisition unit 11 and the first acquisition unit 21 described in the first example embodiment, the acquisition unit 11 is also referred to as an acquisition unit 11 (21). The acquisition unit 11 may also be referred to as a second acquisition unit 11. Since the calculation unit 13 functions as the calculation unit 13 and the storage unit 14 described in the first example embodiment, the calculation unit 13 is also referred to as a calculation unit 13 (14).

In the control unit 10, schematically,
processing (first processing group) of:
acquiring input data including a sentence group;
generating a passage set including a plurality of passages included in the sentence group;
calculating, by using a language model, association information which includes a strength of association between the plurality of passages included in the passage set and is referred to in retrieval processing; and
storing the association information in association with the plurality of passages, and
processing (second processing group) of:
acquiring a query;
retrieving an initial passage related to the query from the passage set including the plurality of passages (first retrieval processing);
retrieving an additional passage from the passage set with reference to the association information including the strength of association between the passages included in the passage set, and the initial passage (second retrieval processing); and
performing retrieval processing (third retrieval processing) using the initial passage and the additional passage
are performed. In the following description, the first processing group is also referred to as processing in an indexing phase, and the second processing group is also referred to as processing in a retrieval phase.

### (Acquisition Unit 11 (21))

The acquisition unit 11 (21) acquires the input data including the sentence group IND in the indexing phase. The sentence group IND acquired by the acquisition unit 11 (21) is stored in the storage unit 20 as an example. Here, the sentence group IND includes, as an example, one or a plurality of documents including a plurality of sentences described in a natural language, and the present example embodiment is not limited thereto. Furthermore, the language of the sentence group IND is not particularly limited.

The acquisition unit 11 (21) acquires the query QR in the retrieval phase. The query QR acquired by the acquisition unit 11 (21) is stored in the storage unit 20 as an example. Here, the query QR is described in a natural language as an example, but the present example embodiment is not limited thereto. Furthermore, the language of the query QR is not particularly limited.

### (Generation Unit 12)

In the indexing phase, the generation unit 12 generates the passage set PG including the plurality of passages PS included in the sentence group IND. As an example, the generation unit 12 performs processing of extracting the plurality of passages PS from the sentence group IND and including, in the passage set PG, the plurality of extracted passages PS. Here, the passage PS may be a unit such as a paragraph, a sentence, a phrase, a word, or a morpheme included in the sentence group IND, or may be another unit. As an example, the passage may be a group of a predetermined number of characters extracted from the sentence group.

### (Calculation Unit 13)

In the indexing phase, the calculation unit 13 calculates the association information AI which includes a strength of association between the plurality of passages PS included in the passage set PG and is referred to in the retrieval processing, by using the language model LM. Here, a specific example of the calculation of the association information using the language model LM does not limit the present example embodiment.

As an example, processing of:
acquiring a similar passage p_{b} similar to a certain passage pₐ for the passage pₐ by using an embedding model EM; and
computing a generation probability LM (pₐ/p_{b}) of the passage pₐ by the language model LM in a case where the similar passage p_{b} is given, and setting the generation probability as a score s_{ab} indicating a strength of association between the passages pₐ and p_{b} may be performed, or
processing of
setting cosine similarity between the certain passage pₐ and the similar passage p_{b} as the score s_{ab} indicating the strength of association between the passage pₐ and the similar passage p_{b} may be performed. Here, the embedding model EM is an example of a model included in the model group MG stored in the storage unit 20. In addition, in order to acquire the generation probability LM (pₐ|p_{b}), the calculation unit 13 may also adopt a configuration in which
an instruction (also referred to as a generation probability instruction prompt) to calculate the generation probability LM (pₐ/p_{b}) of the passage pₐ and the similar passage p_{b} is transmitted to the first server apparatus 50 via the communication unit 30, and
a response to the instruction by the language model LM is acquired via the communication unit 30, the response including the generation probability LM (pₐ|p_{b}).

As a more specific example, in a case where passages p₁, p₂, and p₃ are included in the passage set, the calculation unit 13 may perform processing of:
calculating a score indicating a strength of association defined for each passage pair for a plurality of passage pairs like
a score s₁₂ indicating a strength of association between the passages p₁ and p₂,
a score s₂₃ indicating a strength of association between the passage p₂ and p₃, and
a score s₃₁ indicating a strength of association between the passage p₃ and p₁, and
including, in the association information, the calculated score.

The calculation unit 13 stores the association information AI in association with the plurality of passages PS. As an example, the calculation unit 13 stores the association information AI in the storage unit 20. The stored association information AI is referred to in the retrieval phase described above as an example. A more specific example of processing performed by the calculation unit 13 is described below.

### (First Retrieval Unit 22)

In the retrieval phase, the first retrieval unit 22 retrieves the initial passage IP related to the query QR from the passage set PG including the plurality of passages PS. Here, as an example, a passage set generated by the generation unit 12 in the indexing phase can be used as the passage set PG. In the present example embodiment, the term “initial passage” is also merely used for convenience of description of processing, and the present example embodiment is not limited by the term. The “initial passage” may be expressed as a “first passage”, a “first type of passage”, or the like. A specific example of processing performed by the first retrieval unit 22 is described below.

### (Second Retrieval Unit 23)

In the retrieval phase, the second retrieval unit 23 retrieves the additional passage AP from the passage set PG with reference to the association information AI including the strength of association between the passages PS included in the passage set PG, and the initial passage IP. Here, as an example, information calculated in advance by the calculation unit 13 (14) can be used as the association information AI. In the present example embodiment, the term “additional passage” is also merely used for convenience of description of processing, and the present example embodiment is not limited by the term. The “additional passage” may be expressed as a “second passage”, a “second type of passage”, or the like. A specific example of processing performed by the second retrieval unit 23 is described below.

### (Third Retrieval Unit 24)

The third retrieval unit 24 performs the retrieval processing using the initial passage and the additional passage in the retrieval phase. As illustrated in FIG. 5, as an example, the third retrieval unit 24 includes a prompt generation unit 241 and a generation result acquisition unit 242. As an example, the third retrieval unit 24 may be configured to:
generate, by the prompt generation unit 241, the prompt PR including the initial passage IP and the additional passage AP,
transmit the prompt PR to the second server apparatus 60 via the communication unit 30,
perform the retrieval processing (generation processing) by inputting the prompt PR to the generation model GM, and
acquire, by the generation result acquisition unit 242, a retrieval result (generation result) of the generation model GM. A specific example of processing performed by the third retrieval unit 24 is described below.

### (Output Data Generation Unit 25)

The output data generation unit 25 generates the output data OUT with reference to the retrieval result (generation result) of the generation model GM. As an example, the generated output data OUT is visually presented to the user via the input/output unit 40.

### (Flow of Processing in Indexing Phase)

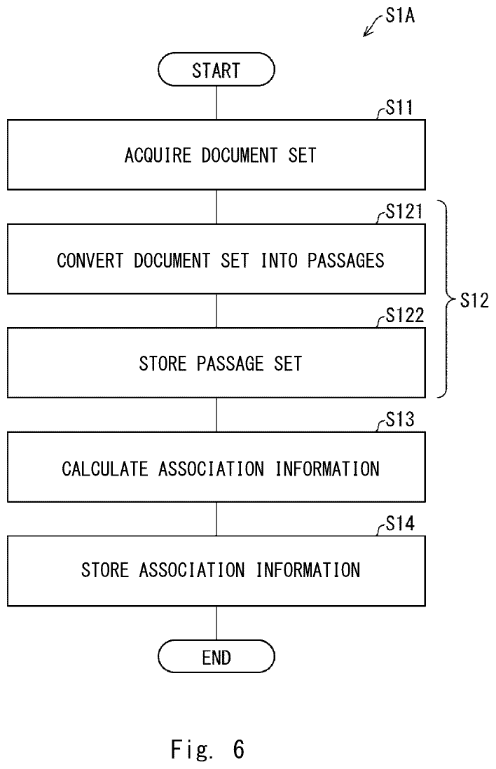

Next, a flow of processing in the indexing phase performed by the information processing apparatus 100 will be described with reference to FIGS. 6 to 8. FIG. 6 is a flowchart illustrating an example of the flow of the processing in the indexing phase.

### (Step S11)

In step S11, the acquisition unit 11 acquires the input data including the sentence group IND.

### (Steps S121 and S122)

In step S121, the generation unit 12 generates the passage set PG including the plurality of passages PS included in the sentence group IND. Then, in step S122, the generation unit 12 stores the generated passage set PG in the storage unit 20.

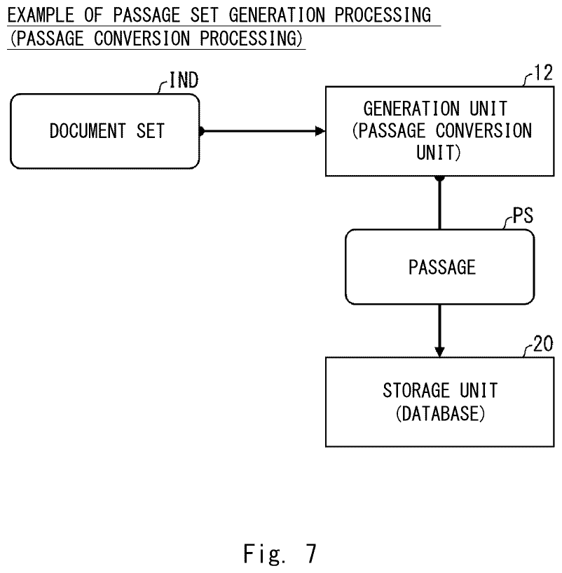

FIG. 7 is a diagram for describing a specific example of passage set generation processing performed by the generation unit 12. As illustrated in FIG. 7, the sentence group IND (also referred to as a document set in FIG. 7) is input to the generation unit 12 (also referred to as a passage conversion unit in FIG. 7), and the generation unit 12 divides the document set into the plurality of passages PS and stores the passages PS obtained by the division in the storage unit 20 (also referred to as a database in FIG. 7) as elements of the passage set PG. The passage set generation processing may be referred to as passage conversion processing, passage extraction processing, or the like. Further, the document set IND as a set of documents di may be expressed by

$$[ Math . 1 ]$$

$$D {=}^{def} {\{ {d}_{i} \}}_{i} . \qquad ( Formula 1 )$$

Further, the passage set PG as a set of passages pⱼ may be expressed by

$$[ Math . 2 ]$$

$$P {=}^{def} {\{ {p}_{j} \}}_{j} . \qquad ( Formula 2 )$$

As described above, the passage PS may be a unit such as a paragraph, a sentence, a phrase, a word, or a morpheme included in the document set IND, but is not limited thereto. As an example, the generation unit 12 may divide a plurality of text files included in the document set IND in units of about 1000 characters, and use a sentence group obtained by the division as the passages PS or the passage set PG.

### (Steps S13 and S14)

Next, in step S13, the calculation unit 13 calculates the association information AI which includes the strength of association between the plurality of passages PS included in the passage set PG and is referred to in the retrieval processing, by using the language model LM. Then, in step S14, the calculation unit 13 stores the association information AI in the storage unit 20 in association with the plurality of passages PS.

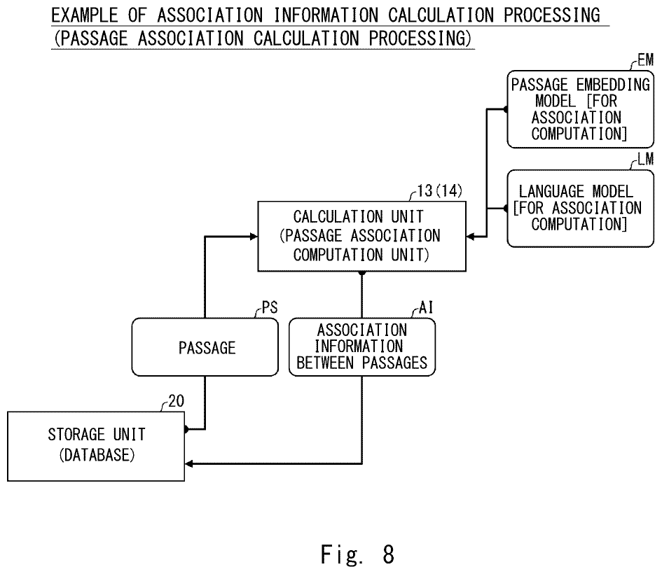

FIG. 8 is a diagram for describing a specific example of association information calculation processing performed by the calculation unit 13. As illustrated in FIG. 8, the calculation unit 13 (also referred to as a passage association computation unit in FIG. 8) performs processing of:
reading the plurality of passages PS from the storage unit 20;
calculating the association information AI including the strength of association between the plurality of passages PS by using the passage embedding model EM and the language model LM; and
storing the calculated association information AI in the storage unit 20.

Here, the passage set PG (the plurality of passages PS) input to the calculation unit 13 may be expressed by

$$[ Math . 3 ]$$

$$P {=}^{def} {\{ {p}_{j} \}}_{j} . \qquad ( Formula 3 )$$

The passage embedding model EM may also be indicated by Mₛᵢₘ. The calculation unit 13 calculates the association information AI including a score indicating a strength of association between some or all of the passages pⱼ included in the passage set PG. As an example, the calculation unit 13 calculates the association information AI (indicated by C in the following formula) by

$$[ Math . 4 ]$$

$${}^{∀} ( {p}_{a} , {p}_{b} ) ∈ U ⊆ P \times P , C = \{ ( {p}_{a} , {p}_{b} , {s}_{ab} ) \} . \qquad ( Formula 4 )$$

Here, pₐ and p_{b} represent the passages included in the passage set PG, and s_{ab} represents the score representing the strength of association between the passage pₐ and the passage p_{b}. The score may be referred to as the association information AI. In addition, the association information calculation processing may be referred to as passage association computation processing or the like.

More specifically, the association information calculation processing performed by the calculation unit 13 may include the following processing.

### (Step S131: Processing of Identifying Set of Associated Passages)

The calculation unit 13 computes embeddings

$$[ Math . 5 ]$$

$${E}_{sim} {=}^{def} {\{ {e}_{j} \}}_{j} \qquad ( Formula 5 )$$

for all the passages by using the embedding model Mₛᵢₘ for association computation. Here, “embedding” refers to “vectorization in a feature space” as an example, and “embedding” is also expressed as “embedding vector”.

Then, the calculation unit 13 calculates cosine similarity between an embedding eₐ and an embedding e_{b} as similarity between all the passage pairs (similarity between the passage pₐ and the passage p_{b})

$$[ Math . 6 ]$$

$${}^{∀} ( {p}_{a} , {p}_{b} ) ∈ P \times P . \qquad ( Formula 6 )$$

Here,
the embedding eₐ is a vector in the feature space and is a vector generated (converted) from the passage pₐ using the embedding model Mₛᵢₘ, and
the embedding e_{b} is a vector in the feature space and is a vector generated (converted) from the passage p_{b} using the embedding model Mₛᵢₘ.

Then, as an example, the calculation unit 13 acquires k passages having higher similarity for each passage pₐ.

Alternatively, the calculation unit 13 may be configured to acquire the k passages having higher similarity for each passage pₐ by using processing of selecting a set of passages that have been extracted from the same document.

### (Step S132: Processing of Computing Association Information of Set of Passages)

Then, the calculation unit 13
calculates the generation probability LM (pₐ|p_{b}) of the passage pₐ by the language model LM in a case where the similar passage p_{b} similar to the passage pₐ is given for the passage pₐ, and
set the calculated generation probability LM (pₐ|p_{b}) as the score s_{ab} representing the strength of association between the passage pₐ and the passage p_{b}. The score can be
a score indicating naturalness with which pₐ appears after the passage p_{b} in a sentence, or
a score indicating how favorable the passage p_{b} is as a contextual passage for the passage pₐ. The cosine similarity between the embedding eₐ and the embedding e_{b} may be used as the score s_{ab} indicating the strength of association between the passage pₐ and the passage p_{b}.

### (Flow of Processing in Retrieval Phase)

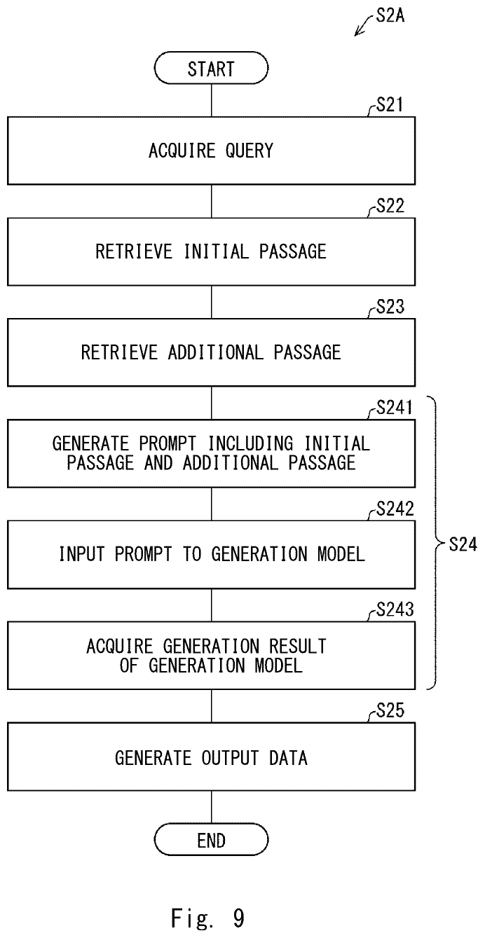

Next, a flow of processing in the retrieval phase performed by the information processing apparatus 100 will be described with reference to FIGS. 9 to 13. FIG. 9 is a flowchart illustrating an example of the flow of the processing in the retrieval phase.

### (Steps S21 and S22)

In step S21, the first acquisition unit 21 acquires the query QR. Then, in step S22, the first retrieval unit 22 retrieves the initial passage IP related to the query QR from the passage set PG including the plurality of passages PS. In the following description, the query QR is also referred to as a query q.

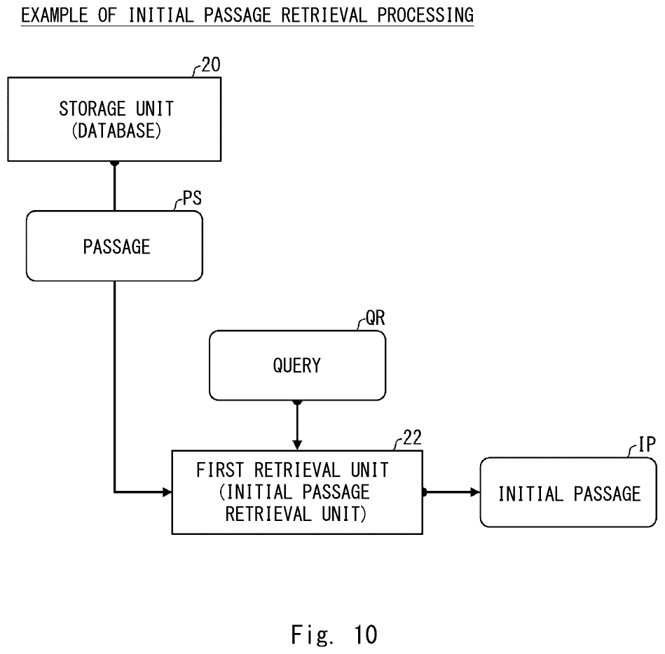

FIG. 10 is a diagram illustrating an example of initial passage retrieval processing performed by the first retrieval unit 22. As illustrated in FIG. 10, the first retrieval unit 22 (also referred to as an initial passage retrieval unit in FIG. 10) retrieves the initial passage IP with reference to the query QR (q) and the plurality of passages PS included in the passage set PG (P) stored in the storage unit 20. As an example, the first retrieval unit 22 performs processing of:
acquiring k passages most related to the query q from the passage set P; and
outputting the acquired k passages as the initial passages IP. Here, the initial passage IP may be indicated by Pᵢₙᵢₜ

$$[ Math . 7 ]$$

$${p}_{init} ⊆ P . \qquad ( Formula 7 )$$

More specifically, the first retrieval unit 22 may perform processing of:
converting the query q into a retrieval vector by using an embedding model M_{idx} for retrieval;
computing similarity with an embedding vector E_{idx} of each passage that has been calculated in the indexing phase by using the converted retrieval vector; and
outputting a predetermined number of (for example, five) passages similar to the query q as the initial passages Pᵢₙᵢₜ. The embedding model M_{idx} for retrieval is an example of a model included in the model group MG stored in the storage unit 20.

### (Step S23)

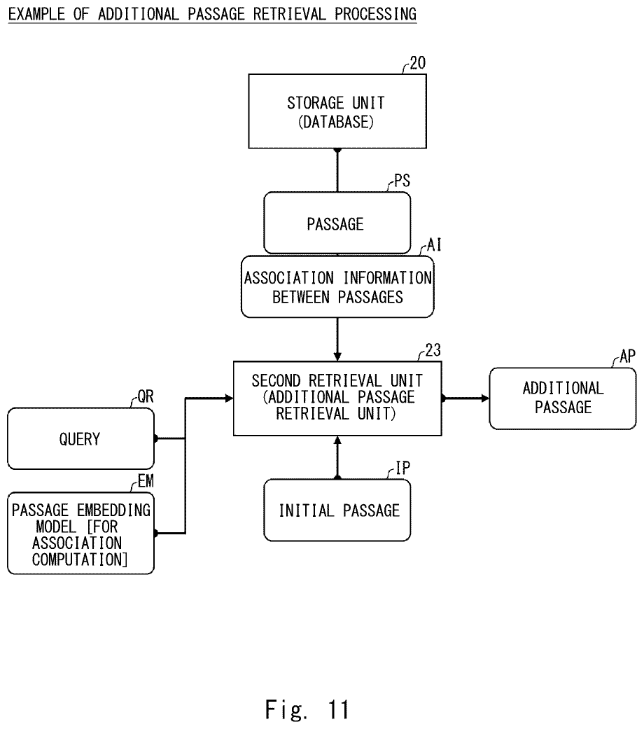

Subsequently, in step S23, the second retrieval unit 23 retrieves the additional passage AP from the passage set PG with reference to the association information AI including the strength of association between the passages included in the passage set PG, and the initial passage IP. FIG. 11 is a diagram illustrating an example of additional passage retrieval processing performed by the second retrieval unit 23. As illustrated in FIG. 11,
the second retrieval unit 23 (also referred to as an additional passage retrieval unit in FIG. 11) retrieves the additional passage AP with reference to
the query QR (q),
the passage embedding model EM (Mₛᵢₘ),
the plurality of passages PS (P) included in the passage set PG,
the association information AI (C) between the passages, and
the initial passage IP (Pᵢₙᵢₜ). Here, the additional passage may be indicated by P_{second}.

The processing performed by the second retrieval unit 23 can also be expressed as processing of additionally acquiring a passage that is strongly dependent on the initial passage Pᵢₙᵢₜ and is related to the query q, by using the query q, the initial passage Pᵢₙᵢₜ, and the association information C between the passages. Here, the number of passages to be additionally acquired (the number of additional passages P_{second}) can be arbitrarily determined.

More specifically, the additional passage retrieval processing performed by the second retrieval unit 23 may include the following processing.

### (Step S231: Processing of Computing Information (Directed Graph) to be Used for Retrieval of Additional Passage)

The second retrieval unit 23 calculates a graph G (V, E) in which
all the passages included in the association information C between the passages

$$[ Math . 8 ]$$

$$C = \{ ( {p}_{a} , {p}_{b} , {s}_{ab} ) \} \qquad ( Formula 8 )$$

are represented by nodes V

$$[ Math . 9 ]$$

$$V = \{ {p}_{a} \vert ( {p}_{a} , {p}_{b} , {s}_{ab} ) ∈ C \} ⋃ \{ {p}_{b} \vert ( {p}_{a} , {p}_{b} , {s}_{ab} ) ∈ C \} , \qquad ( Formula 9 )$$

and all the passage pairs are represented by edges E

$$[ Math . 10 ]$$

$$E = \{ ( {p}_{a} , {p}_{b} ) \vert ( {p}_{a} , {p}_{b} , {s}_{ab} ) ∈ C \} . \qquad ( Formula 10 )$$

Here, an edge (pₐ, p_{b}) defined by the passages pₐ and p_{b} is defined as a directed edge from pₐ to p_{b} as an example. Therefore, the graph G (V, E) is also expressed as the directed graph G (V, E). The above processing is merely an example, and does not limit the present example embodiment. For example, instead of assigning an edge between all the nodes, an edge may be assigned only to k passages having the highest association score s_{ab}.

### (Step S232: Processing of Retrieving Additional Passage by Using Information (Directed Graph) Described Above)

Then, the second retrieval unit 23 executes a retrieval algorithm including the following processing.
A “transition probability (weight) in the case of random node transition” is uniformly set for the initial passage Pᵢₙᵢₜ.
Then, a weight of the edge is uniformly set also for the edge from each node.
Then, m passages having the highest score PR (p) according to the algorithm other than the initial passage are specified.
Then, the specified m passages are output as the additional passages P_{second}.

Here, a method of calculating the score PR (p) does not limit the present example embodiment, and as an example, the score PR (p) for a certain passage p may be determined with reference to at least one of:
a weight given to an edge having the corresponding passage as an end point, and
a weight given to a passage as a start point of an edge having the corresponding passage as an end point. Furthermore, a PageRank algorithm may be used as the method of calculating the score PR (p).

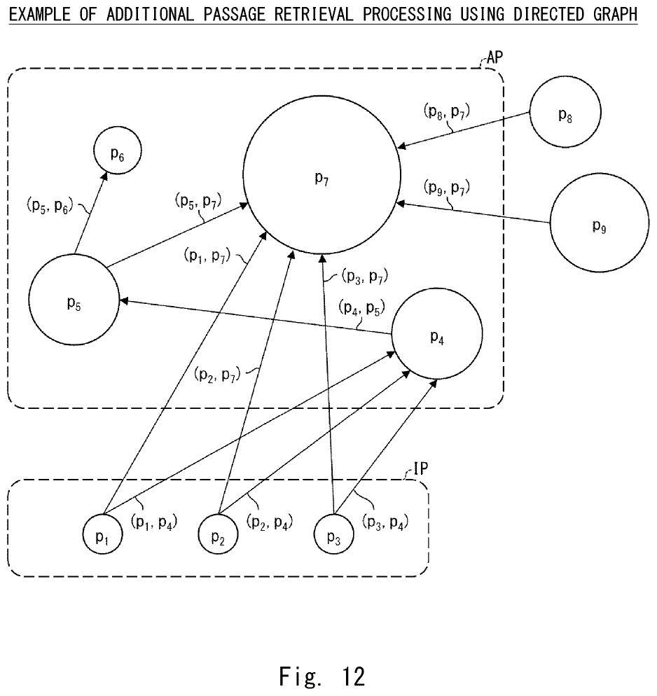

FIG. 12 illustrates, as an example of the directed graph G (V, E) referred to by the second retrieval unit 23, a graph G (V, E) including
the initial passage Pᵢₙᵢₜ (denoted as IP in FIG. 12), and
the additional passage P_{second} (denoted as AP in FIG. 12) retrieved according to the above algorithm.

As described above, the second retrieval unit 23 may perform processing of retrieving the additional passage AP (P_{second}) from the passage set PG with reference to the directed graph G (V, E) including one or a plurality of edges (pₐ, p_{b}) defined by one or a plurality of passage pairs (pₐ and p_{b}) included in the association information AI (C).

In this step, the second retrieval unit 23 may be configured to execute the algorithm by using a value of the association score s_{ab} as the weight of the edge for the edge (pₐ, p_{b}) having each passage pₐ as a start point. For example, any one of the following processing examples or a combination thereof may be performed.

### Processing Example 1

The second retrieval unit 23 may set, as the weight of the edge (pₐ, p_{b}), a value of s_{ab}/M normalized by dividing the value of s_{ab} by M defined by

$$[ Math . 11 ]$$

$$M = {\sum }_{{p}_{b}} ∈ N ( {p}_{a} ) {s}_{ab} . \qquad ( Formula 11 )$$

Here, N (pₐ) refers to a set of nodes directly connected to pₐ by edges.

### Processing Example 2

Alternatively, the second retrieval unit 23 may be configured to compute a rank r_{b} (a position from the top) of the passage p_{b} by using the value of s_{ab}. For example, the second retrieval unit 23 may
compute a reciprocal 1/r_{b} of the rank r_{b},
normalize the reciprocal, and
set the normalized reciprocal as the weight of the edge (pₐ, p_{b}).

In addition, the above Processing Example 1 and Processing Example 2 may be used in combination with the following Processing Example 3.

### Processing Example 3

The second retrieval unit 23 may set the “transition probability in the case of random node transition” by using the score or order assigned to the node belonging to the initial passage Pᵢₙᵢₜ. For example, in a case where a passage whose cosine similarity between the embeddings of the query q and the passage is high is selected as the initial passage Pᵢₙᵢₜ, the cosine similarity can be used as the score assigned to the node belonging to Pᵢₙᵢₜ.

In each step of processing described above, a transition probability of 0 may be assigned to nodes other than the node belonging to Pᵢₙᵢₜ.

In addition, the following Processing Example 4 may be performed instead of or together with each of the above-described Processing Examples.

### Processing Example 4

In the present processing example, the second retrieval unit 23 performs processing of retrieving the additional passage AP (P_{second}) from the passage set PG by referring to a partial directed graph G′ (V′, E′), which is obtained by referring to the initial passage IP (Pᵢₙᵢₜ) and the association information AI (C) and forms a part of the directed graph G (V, E). Processing Example 4 includes the following steps S41 and S42.

### (Step S41)

First, the second retrieval unit 23 calculates the directed graph G (V, E) in which
all the passages included in the association information C between the passages

$$[ Math . 12 ]$$

$$C = \{ ( {p}_{a} , {p}_{b} , {s}_{ab} ) \} \qquad ( Formula 12 )$$

are represented by nodes V

$$[ Math . 13 ]$$

$$V = \{ {p}_{a} \vert ( {p}_{a} , {p}_{b} , {s}_{ab} ) ∈ C \} ⋃ \{ {p}_{b} \vert ( {p}_{a} , {p}_{b} , {s}_{ab} ) ∈ C \} , \qquad ( Formula 13 )$$

and all the passage pairs are represented by edges E

$$[ Math . 14 ]$$

$$E = \{ ( {p}_{a} , {p}_{b} ) \vert ( {p}_{a} , {p}_{b} , {s}_{ab} ) ∈ C \} . \qquad ( Formula 14 )$$

### (Step S42)

Subsequently, the second retrieval unit 23 specifies a passage set that can be reached by n movements from the initial passage Pᵢₙᵢₜ in the directed graph G (V, E). Here, the passage set that can be reached by the n movements is also referred to as a passage set A.

Then, the second retrieval unit 23 calculates the directed graph G′ (V′, E′) defined by a node V′

$$[ Math . 15 ]$$

$${V}^{′} = \{ p \vert p ∈ A and p ∈ V \} \qquad ( Formula 15 )$$

and an edge E′

$$[ Math . 16 ]$$

$${E}^{′} = \{ ( {p}_{a} , {p}_{b} ) \vert ( {p}_{a} , {p}_{b} ) ∈ E and {p}_{a} , {p}_{b} ∈ {V}^{′} \} . \qquad ( Formula 16 )$$

Then, the above-described retrieval algorithm is executed using the directed graph G′ (V′, E′). Since the directed graph G′ (V′, E′) is a partial graph of the graph G (V, E), the directed graph G′ (V′, E′) may be referred to as a partial directed graph G′ (V′, E′).

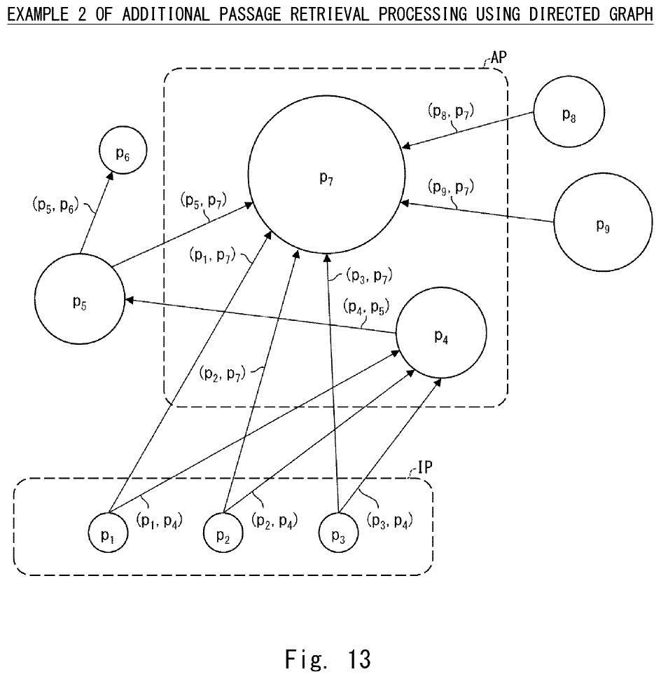

FIG. 13 illustrates an example of the partial directed graph G′ (V′, E′) referred to by the second retrieval unit 23 that performs the present processing example. In FIG. 13, the partial directed graph indicates the partial directed graph G′ (V′, E′) including
the initial passage Pᵢₙᵢₜ (denoted as IP in FIG. 12),
the additional passage P_{second} (denoted as AP in FIG. 12) which is retrieved by the above-described algorithm and is reachable by one movement from the initial passage Pᵢₙᵢₜ.

At least a part of the directed graph G (V, E) illustrated in FIG. 12 or at least a part of the partial directed graph G′ (V′, E′) illustrated in FIG. 13 may be visually presented to the user via the input/output unit 40. As an example, the second retrieval unit 23 may perform processing of:
presenting the directed graph G (V, E) to the user;
receiving a user instruction (as an example, input of a specific value of n described above) related to the directed graph G (V, E); and
calculating the partial directed graph G′ (V′, E′) reflecting the instruction from the user and presenting the partial directed graph G′ (V′, E′) to the user.

In addition, the following Processing Example 5 may be performed instead of or together with each of the above-described Processing Examples.

### Processing Example 5

In Processing Example 5, the second retrieval unit 23 performs processing of retrieving the additional passage AP (P_{second}) from the passage set PG with reference to a first score which indicates a strength of association between a passage pair defining each of the one or plurality of edges (pₐ, p_{b}) and is calculated in advance without referring to the query QR (q), and a second score which indicates the strength of association between the passage pair defining each of the one or plurality of edges (pₐ, p_{b}) and is calculated with reference to the query QR (q). Processing Example 5 includes the following steps S51 and S52.

### (Step S51: Processing of Computing Association Between Passages Using Query)

The second retrieval unit 23 calculates the second score f (q, pₐ, p_{b}) with reference to the query QR (q) by

$$[ Math . 17 ]$$

$$f ( q , {p}_{a} , {p}_{b} ) = sim ( {e}_{q} , {e}_{a + b} ) - sim ( {e}_{q} , {e}_{a} ) . \qquad ( Formula 17 )$$

Here, the expressions in the formula are as follows.
e_{q}: the embedding of the query q
eₐ: the embedding of the passage pₐ
e_{a+b}: an embedding obtained by combining the passage pₐ and the passage p_{b} in a character string manner, and
sim: the cosine similarity between the embeddings. The second score can also be regarded as a “degree to which the passage p_{b} serves as a more favorable contextual passage for the query q in a case where the query q and the passage pₐ are given”.

The second retrieval unit 23 calculates the second score f (q, pₐ, p_{b}) for all the edges (pₐ, p_{b}) of the directed graph G (V, E) or the partial directed graph G′ (V′, E′) by using the association information C between the passages

$$[ Math . 18 ]$$

$$C = \{ ( {p}_{a} , {p}_{b} , {s}_{ab} ) \} . \qquad ( Formula 18 )$$

In calculation processing for the second score f (q, pₐ, p_{b}), processing of calculating
eₐ: the embedding of the passage pₐ, and
e_{a+b}: the embedding obtained by combining the passage pₐ and the passage p_{b} in a character string manner
can be performed in advance in the indexing phase. With such a configuration, in the retrieval phase, it is sufficient if
e_{q}: the embedding of the query q, and
sim: the cosine similarity between the embeddings
can be calculated. Since the calculation processing can be performed without using the language model LM, an increase in processing amount in the retrieval phase can be suppressed even with a configuration utilizing the second score as described above, as a result of which user convenience is not impaired.

### (Step S52: Processing of Aggregating Association Information Between Passages Computed Using Query and Association Information Between Passages Computed in Advance)

In this step, for each node (passage) pₐ of the directed graph G (V, E), a set N (pₐ) of nodes directly connected from the node pₐ by edges is considered. The set N (pₐ) can be regarded as a set of nodes near the node pₐ. Here, for the edge (pₐ, p_{b})

$$[ Math . 19 ]$$

$$( {p}_{a} , {p}_{b} ) , {p}_{b} ∈ N ( {p}_{a} ) , \qquad ( Formula 19 )$$

the score s_{ab} (the first score) representing the strength of association computed in advance in the indexing phase, and
the score f (q, pₐ, p_{b}) (the second score) representing the strength of association computed in consideration of the query q in step S51
are determined.

As an example, the second retrieval unit 23 performs processing of:
computing the rank r_{b} (a position from the top) of each passage p_{b} belonging to the set N (pₐ) by using each of the scores (the first score and the second score); and
creating one ranking by aggregating two computed rankings. As an example, the second retrieval unit 23 calculates the score of p_{b} as

|N(pₐ)|−r_{b}+1
by using a Borda score. Here, |N(pₐ)| represents the number of elements of the set N (pₐ). Then, as an example, the second retrieval unit 23 can derive a ranking obtained by aggregating the first score and the second score by
summing the Borda scores in the two rankings, and
sorting p_{b} in descending order of total score. Then, the second retrieval unit 23 recomputes the score (aggregated score) for each edge based on the aggregated ranking. For example, the second retrieval unit 23 calculates the aggregated score by using a reciprocal of the aggregated ranking.

The second retrieval unit 23 can calculate a score obtained by aggregating the first score and the second score for each edge by performing the above processing for all the passages pₐ. In other words, by performing the above processing, the second retrieval unit 23 can calculate a new graph G considering the query q in evaluation of the association between the passages and can retrieve the additional passage AP (P_{second}) by using the new graph G.

As described above, in the present processing example, a configuration in which the second retrieval unit 23 retrieves the additional passage AP (P_{second}) from the passage set PG by using the score obtained by aggregating the first score s_{ab} and the second score f (q, pₐ, p_{b}) for each of the one or plurality of edges (pₐ, p_{b}) is adopted.

As described above, in the present processing example,
the processing of calculating
eₐ: the embedding of the passage pₐ, and
e_{a+b}: the embedding obtained by combining the passage pₐ and the passage p_{b} in a character string manner
can be performed in advance in the indexing phase. The calculation processing can be performed by using the language model LM as an example and utilizing a large amount of information of the language model LM. On the other hand,
the processing of calculating
e_{q}: the embedding of the query q, and
sim: the cosine similarity between the embeddings
and the processing of aggregating the first score and the second score can be performed using a lightweight embedding model without using the language model.

Therefore, with the above configuration, passage evaluation in consideration of the query q and the retrieval of the additional passage AP (P_{second}) can be appropriately performed without impairing the user convenience.

Returning to FIG. 9, the description will be continued.

### (Steps S241, S242, and S243)

The prompt generation unit 241 generates the prompt PR in step S241 by using the initial passage IP retrieved in step S22 and the additional passage AP retrieved in step S23. Here, the prompt includes the initial passage IP and the additional passage AP.

Then, in step S242, the prompt generation unit 241 inputs the generated prompt PR to the generation model GM via the communication unit 30. Then, in step S243, the generation result acquisition unit 242 acquires the generation result GR generated by the generation model GM based on the prompt PR.

### <Application Example>

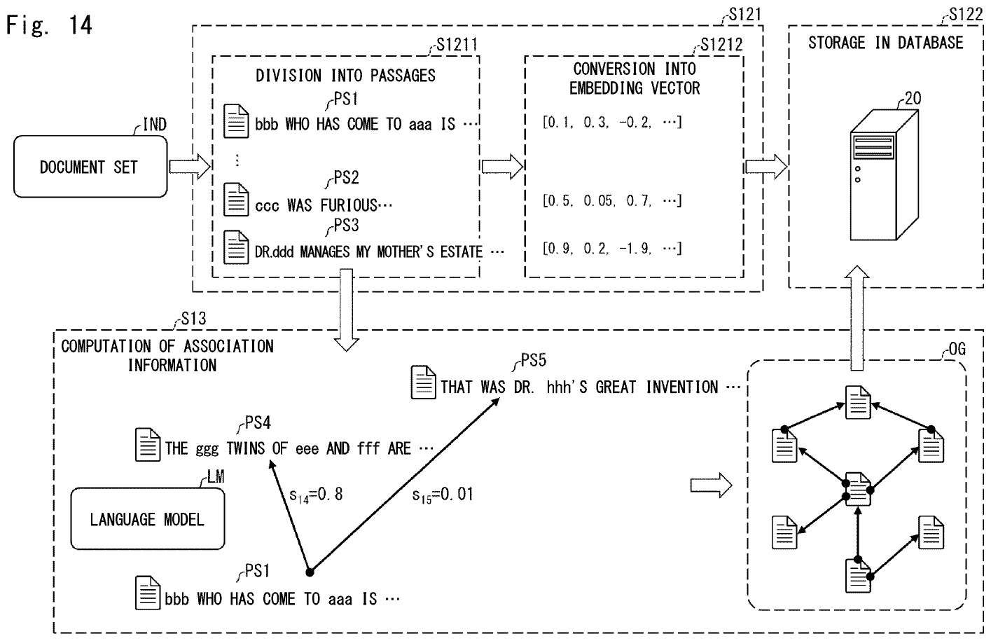

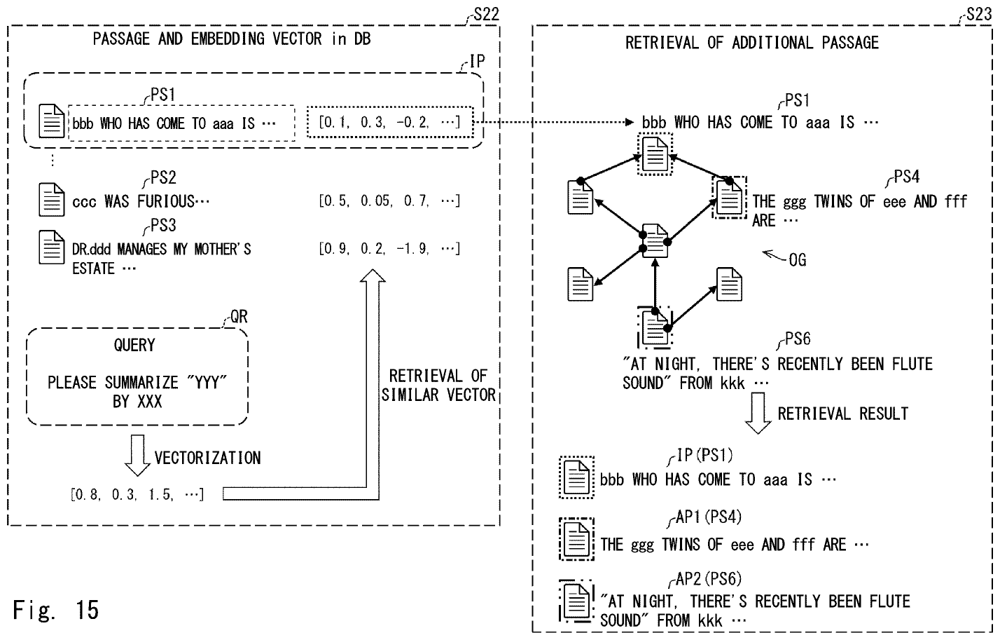

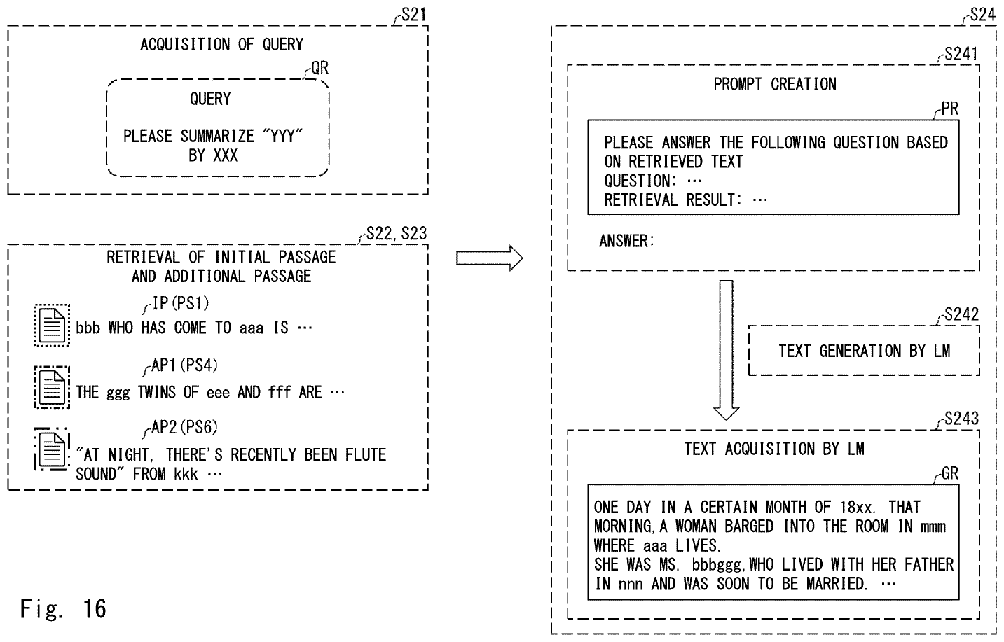

Hereinafter, an application example of the information processing system 1A according to the present example embodiment will be described with reference to FIGS. 14 to 16. FIG. 14 illustrates a processing example mainly in the indexing phase, and FIGS. 15 and 16 illustrate processing examples mainly in the retrieval phase.

First, as illustrated in FIG. 14, the document set IND is input and acquired by the acquisition unit 11 (21). Then, the document set IND is converted into a plurality of passages by the generation unit 12 (corresponding to step S121 described above). Here, as illustrated in FIG. 14, the conversion processing includes:
processing of dividing the document set IND into a plurality of passages (PS1, PS2, PS3, and the like) (S1211 in FIG. 14); and
processing of converting each passage into an embedding vector (S1212 in FIG. 14). Here, the processing of converting each passage into the embedding vector can be performed by the embedding model EM described above as an example.

Then, one or both of each divided passage and the embedding vector corresponding to each passage are stored in the storage unit 20 (a database in FIG. 14) (S122 in FIG. 14).

As illustrated in FIG. 14, the calculation unit 13 (14) calculates the association information AI (C) between each of the passages (PS1, PS2, PS3, and the like) and a passage connected to the corresponding passage via an edge (S13 in FIG. 14).

In the example illustrated in FIG. 14,
s₁₄=0.8 is calculated as the association information (association score) between the passage PS1 and the passage PS4, and
s₁₅=0.01 is calculated as the association information (association score) between the passage PS1 and the passage PS5.

These pieces of association information AI (C) are stored in the storage unit 20 (the database in FIG. 14) together with a directed graph OG formed by the plurality of passages (PS1, PS2, PS3, and the like).

Meanwhile, as illustrated in FIG. 15, in a case where the query QR (q) is acquired, the first retrieval unit 22 retrieves the initial passage IP (Pᵢₙᵢₜ) related to the query QR (q) from the plurality of passages (PS1, PS2, PS3, and the like). In the example illustrated in FIG. 15, the first retrieval unit 22 specifies the initial passage IP (Pᵢₙᵢₜ) (s₂₂ in FIG. 15) by
converting the query QR (q) into an embedding vector, and
retrieving a vector similar to the corresponding vector from the plurality of passages (PS1, PS2, PS3, and the like).

Then, the second retrieval unit 23 retrieves the additional passage AP ((P_{second})) with reference to the initial passage IP (Pᵢₙᵢₜ) and the association information AI (C) accompanying the directed graph OG (s₂₃ in FIG. 15). In the example illustrated in FIG. 15, as additional passages for the initial passage IP (PS1) of “bbb who has come to aaa is . . . ”,
a passage “The ggg twins of eee and fff are . . . ” (AP1 (PS4)), and
a passage “At night, there's recently been flute sound” from kkk (AP2 (PS6))
are retrieved.

Then, as illustrated in FIG. 16, the third retrieval unit 24 generates the prompt PR with reference to
the query QR (q),
the initial passage IP, and
the additional passage AP
(S241 in FIG. 16). Then, the third retrieval unit 24 inputs the generated prompt PR to the generation model GM or the language model LM to acquire a text that is the generation result (retrieval result) (S242 and S243 in FIG. 16). Then, the output data generation unit 25 generates the output data OUT including the acquired generation result (retrieval result) and presents the output data OUT to the user via the input/output unit 40.

### (Effects of Information Processing Apparatus 100)

As described above, in the indexing phase, the information processing apparatus 100 performs processing of:
acquiring the input data including the sentence group IND;
generating the passage set PG including the plurality of passages PS included in the sentence group IND;
calculating the association information C (pₐ, p_{b}, and s_{ab}) which includes the strength of association between the plurality of passages (pₐ and p_{b}) included in the passage set PG and is referred to in the retrieval processing, by using the language model LM; and
storing the association information C (pₐ, p_{b}, and s_{ab}) in association with the plurality of passages (pₐ, p_{b}, and the like). Further, in the retrieval phase, the information processing apparatus 100 performs processing of:
acquiring the query QR;
retrieving the initial passage IP related to the query QR from the passage set PG including the plurality of passages (first retrieval processing);
retrieving the additional passage AP from the passage set PG with reference to the association information C (pₐ, p_{b}, and s_{ab}) including the strength of association between the passages included in the passage set PG, and the initial passage IP (second retrieval processing); and
performing the retrieval processing (third retrieval processing) using the initial passage IP and the additional passage AP. As described above, the information processing apparatus 100 performs processing of calculating and storing the association information to be referred to in the retrieval processing by using the language model. Therefore, in the retrieval processing, it is not necessary to calculate the association information again using the language model. Therefore, with the above configuration, a processing speed in the retrieval processing increases, and user convenience is improved. With the above configuration, the additional passage is retrieved from the passage set with reference to the association information including the strength of association between the passages included in the passage set, and the initial passage, and the retrieval processing is performed using the initial passage and the additional passage. Therefore, self-containedness of information used in the third retrieval processing is improved, and as a result, quality of a finally generated response (a result of the third retrieval processing) is improved.

### [Implementation Example by Software]

Some or all of the functions of the information processing apparatuses 1, 2, and 100 (hereinafter, also referred to as “each of the above apparatuses”) may be implemented by hardware such as an integrated circuit (IC chip) or may be implemented by software.

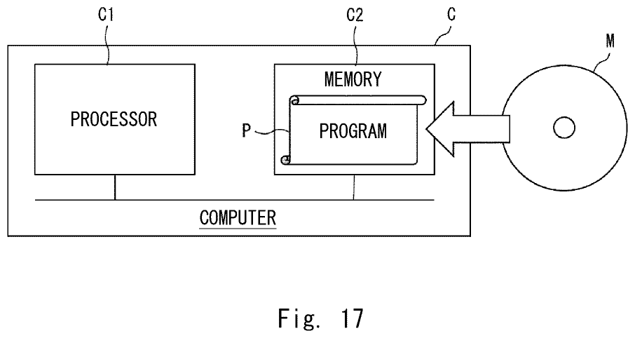

In the latter case, each of the above apparatuses is implemented by, for example, a computer that executes a command of a program that is software for implementing each function. An example of such a computer (hereinafter, referred to as a computer C) is illustrated in FIG. 17. FIG. 17 is a block diagram illustrating a hardware configuration of the computer C functioning as each of the above apparatuses.

The computer C includes at least one processor C1 and at least one memory C2. A program P for operating the computer C as each of the above apparatuses is recorded in the memory C2. In the computer C, the processor C1 reads the program P from the memory C2 and executes the program P to implement each function of each of the above apparatuses.

For example, a central processing unit (CPU), a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof can be used as the processor C1. For example, a flash memory, a hard disk drive (HDD), a solid state drive (SSD), or a combination thereof can be used as the memory C2.

The computer C may further include a random access memory (RAM) for loading the program P at the time of execution and temporarily storing various types of data. Furthermore, the computer C may further include a communication interface for transmitting and receiving data to and from another apparatus. The computer C may further include an input/output interface for connecting input/output devices such as a keyboard, a mouse, a display, and a printer.

In addition, the program P can be recorded in a non-transitory tangible recording medium M readable by the computer C. For example, a tape, a disk, a card, a semiconductor memory, a programmable logic circuit, or the like can be used as such a recording medium M. The computer C can acquire the program P via such a recording medium M. In addition, the program P can be transmitted via a transmission medium. For example, a communication network, a broadcast wave, or the like can be used as such a transmission medium. The computer C can also acquire the program P via such a transmission medium.

Furthermore, each of the above functions of each of the above apparatuses may be implemented by a single processor provided in a single computer, may be implemented by cooperation of a plurality of processors provided in a single computer, or may be implemented by cooperation of a plurality of processors provided in each of a plurality of computers. In addition, the program for causing each of the above apparatuses to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Notes A

The present disclosure includes technologies described in the following supplementary notes. However, the present disclosure is not limited to the technologies described in the following supplementary notes, and various modifications can be made within the scope described in the claims.

### Supplementary Note A1

An information processing apparatus including:
first acquisition means for acquiring a query;
first retrieval means for retrieving an initial passage related to the query from a passage set including a plurality of passages;
second retrieval means for retrieving an additional passage from the passage set with reference to association information including a strength of association between the passages included in the passage set, and the initial passage; and
third retrieval means for performing retrieval processing using the initial passage and the additional passage.

### Supplementary Note A2

The information processing apparatus according to Supplementary Note A1, in which the second retrieval means retrieves the additional passage from the passage set with reference to a directed graph including one or a plurality of edges defined by one or a plurality of passage pairs included in the association information.

### Supplementary Note A3

The information processing apparatus according to Supplementary Note A2, in which the second retrieval means retrieves the additional passage from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

### Supplementary Note A4

The information processing apparatus according to Supplementary Note A3, in which the second retrieval means retrieves the additional passage from the passage set by using a score obtained by aggregating the first score and the second score for each of the one or plurality of edges.

### Supplementary Note A5

The information processing apparatus according to any one of Supplementary Notes A2 to A4, in which the second retrieval means retrieves the additional passage from the passage set with reference to a partial directed graph which is obtained with reference to the initial passage and the association information and forms a part of the directed graph.

### Supplementary Note A6

The information processing apparatus according to any one of Supplementary Notes A1 to A5, further including:
second acquisition means for acquiring input data including a sentence group;
generation means for generating the passage set including the plurality of passages included in the sentence group; and
calculation means for calculating the association information including the strength of association between the plurality of passages included in the passage set.

### Supplementary Note A7

The information processing apparatus according to Supplementary Note A6, in which the calculation means calculates the association information by using a language model.

### Supplementary Note A8

An information processing apparatus including:
acquisition means for acquiring input data including a sentence group;
generation means for generating a passage set including a plurality of passages included in the sentence group;
calculation means for calculating, by using a language model, association information which includes a strength of association between the plurality of passages included in the passage set and is referred to in retrieval processing; and
storage means for storing the association information in association with the plurality of passages.

### Supplementary Notes B

The present disclosure includes technologies described in the following supplementary notes. However, the present disclosure is not limited to the technologies described in the following supplementary notes, and various modifications can be made within the scope described in the claims.

### Supplementary Note B1

An information processing method including:
first acquisition processing of acquiring, by at least one processor, a query;
first retrieval processing of retrieving, by the at least one processor, an initial passage related to the query from a passage set including a plurality of passages;
second retrieval processing of retrieving, by the at least one processor, an additional passage from the passage set with reference to association information including a strength of association between the passages included in the passage set, and the initial passage; and
third retrieval processing of performing, by the at least one processor, retrieval processing using the initial passage and the additional passage.

### Supplementary Note B2

The information processing method according to Supplementary Note B1, in which in the second retrieval processing, the additional passage is retrieved from the passage set with reference to a directed graph including one or a plurality of edges defined by one or a plurality of passage pairs included in the association information.

### Supplementary Note B3

The information processing method according to Supplementary Note B2, in which in the second retrieval processing, the additional passage is retrieved from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

### Supplementary Note B4

The information processing method according to Supplementary Note B3, in which in the second retrieval processing, the additional passage is retrieved from the passage set by using a score obtained by aggregating the first score and the second score for each of the one or plurality of edges.

### Supplementary Note B5

The information processing method according to any one of Supplementary Notes B2 to B4, in which in the second retrieval processing, the additional passage is retrieved from the passage set with reference to a partial directed graph which is obtained with reference to the initial passage and the association information and forms a part of the directed graph.

### Supplementary Note B6

The information processing method according to any one of Supplementary Notes B1 to B5, further including:
second acquisition processing of acquiring, by the at least one processor, input data including a sentence group;
generation processing of generating, by the at least one processor, the passage set including the plurality of passages included in the sentence group; and
calculation processing of calculating, by the at least one processor, the association information including the strength of association between the plurality of passages included in the passage set.

### Supplementary Note B7

The information processing method according to Supplementary Note B6, in which in the calculation processing, the at least one processor calculates the association information by using a language model.

### Supplementary Note B8

An information processing method including:
acquisition processing of acquiring, by at least one processor, input data including a sentence group;
generation processing of generating, by at least one processor, a passage set including a plurality of passages included in the sentence group;
calculation processing of calculating, by at least one processor, association information which includes a strength of association between the plurality of passages included in the passage set and is referred to in retrieval processing by using a language model; and
storage processing of storing, by at least one processor, the association information in association with the plurality of passages.

### Supplementary Notes C

The present disclosure includes technologies described in the following supplementary notes. However, the present disclosure is not limited to the technologies described in the following supplementary notes, and various modifications can be made within the scope described in the claims.

### Supplementary Note C1

An information processing program for causing a computer to function as an information processing apparatus, in which the computer is caused to function as:
first acquisition means for acquiring a query;
first retrieval means for retrieving an initial passage related to the query from a passage set including a plurality of passages;
second retrieval means for retrieving an additional passage from the passage set with reference to association information including a strength of association between the passages included in the passage set, and the initial passage; and
third retrieval means for performing retrieval processing using the initial passage and the additional passage.

### Supplementary Note C2

The information processing program according to Supplementary Note C1, in which the second retrieval means retrieves the additional passage from the passage set with reference to a directed graph including one or a plurality of edges defined by one or a plurality of passage pairs included in the association information.

### Supplementary Note C3

The information processing program according to Supplementary Note C2, in which the second retrieval means retrieves the additional passage from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

### Supplementary Note C4

The information processing program according to Supplementary Note C3, in which the second retrieval means retrieves the additional passage from the passage set by using a score obtained by aggregating the first score and the second score for each of the one or plurality of edges.

### Supplementary Note C5

The information processing program according to any one of Supplementary Notes C2 to C4, in which the second retrieval means retrieves the additional passage from the passage set with reference to a partial directed graph which is obtained with reference to the initial passage and the association information and forms a part of the directed graph.

### Supplementary Note C6

The information processing program according to any one of Supplementary Notes C1 to C5, in which the computer is caused to further function as:
second acquisition means for acquiring input data including a sentence group;
generation means for generating the passage set including the plurality of passages included in the sentence group; and
calculation means for calculating the association information including the strength of association between the plurality of passages included in the passage set.

### Supplementary Note C7

The information processing program according to Supplementary Note C6, in which the calculation means calculates the association information by using a language model.

### Supplementary Note C8

An information processing program for causing a computer to function as:
acquisition means for acquiring input data including a sentence group;
generation means for generating a passage set including a plurality of passages included in the sentence group;
calculation means for calculating, by using a language model, association information which includes a strength of association between the plurality of passages included in the passage set and is referred to in retrieval processing; and
storage means for storing the association information in association with the plurality of passages.

### Supplementary Notes D

The present disclosure includes technologies described in the following supplementary notes. However, the present disclosure is not limited to the technologies described in the following supplementary notes, and various modifications can be made within the scope described in the claims.

### Supplementary Note D1

An information processing apparatus including:
at least one processor,
in which the at least one processor performs:
first acquisition processing of acquiring a query;
first retrieval processing of retrieving an initial passage related to the query from a passage set including a plurality of passages;
second retrieval processing of retrieving an additional passage from the passage set with reference to association information including a strength of association between the passages included in the passage set, and the initial passage; and
third retrieval processing of performing retrieval processing using the initial passage and the additional passage.

The information processing apparatus may further include a memory. In addition, the memory may store a program for causing the at least one processor to perform each step of processing.

### Supplementary Note D2

The information processing apparatus according to Supplementary Note D1, in which in the second retrieval processing, the additional passage is retrieved from the passage set with reference to a directed graph including one or a plurality of edges defined by one or a plurality of passage pairs included in the association information.

### Supplementary Note D3

The information processing apparatus according to Supplementary Note D2, in which in the second retrieval processing, the additional passage is retrieved from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

### Supplementary Note D4

The information processing apparatus according to Supplementary Note D3, in which in the second retrieval processing, the additional passage is retrieved from the passage set by using a score obtained by aggregating the first score and the second score for each of the one or plurality of edges.

### Supplementary Note D5

The information processing apparatus according to any one of Supplementary Notes D2 to D4, in which in the second retrieval processing, the additional passage is retrieved from the passage set with reference to a partial directed graph which is obtained with reference to the initial passage and the association information and forms a part of the directed graph.

### Supplementary Note D6

The information processing apparatus according to any one of Supplementary Notes D1 to D5, in which the at least one processor further performs:
second acquisition processing of acquiring input data including a sentence group;
generation processing of generating the passage set including the plurality of passages included in the sentence group; and
calculation processing of calculating the association information including the strength of association between the plurality of passages included in the passage set.

### Supplementary Note D7

The information processing apparatus according to Supplementary Note D6, in which in the calculation processing, the at least one processor calculates the association information by using a language model.

### Supplementary Note D8

An information processing apparatus in which at least one processor performs:
acquisition processing of acquiring input data including a sentence group;
generation processing of generating a passage set including a plurality of passages included in the sentence group;
calculation processing of calculating, by using a language model, association information which includes a strength of association between the plurality of passages included in the passage set and is referred to in retrieval processing; and
storage processing of storing the association information in association with the plurality of passages.

### Supplementary Notes E

The present disclosure includes technologies described in the following supplementary notes. However, the present disclosure is not limited to the technologies described in the following supplementary notes, and various modifications can be made within the scope described in the claims.

### Supplementary Note E1

A non-transitory recording medium recording an information processing program for causing a computer to function as an information processing apparatus and to perform:
first acquisition processing of acquiring a query;
first retrieval processing of retrieving an initial passage related to the query from a passage set including a plurality of passages;
second retrieval processing of retrieving an additional passage from the passage set with reference to association information including a strength of association between the passages included in the passage set, and the initial passage; and
third retrieval processing of performing retrieval processing using the initial passage and the additional passage.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory configured to store instructions; and
at least one processor configured to execute the instructions to:
acquire a query;
perform first retrieval processing of retrieving an initial passage related to the query from a passage set including a plurality of passages;
perform second retrieval processing of retrieving an additional passage from the passage set with reference to association information including a strength of association between the passages included in the passage set, and the initial passage; and
perform third retrieval processing of performing retrieval processing using the initial passage and the additional passage.

2. The information processing apparatus according to claim 1, wherein, in the second retrieval processing, the processor executes the instructions to retrieve the additional passage from the passage set with reference to a directed graph including one or a plurality of edges defined by one or a plurality of passage pairs included in the association information.

3. The information processing apparatus according to claim 2, wherein, in the second retrieval processing, the at least one processor executes the instructions to retrieve the additional passage from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

4. The information processing apparatus according to claim 3, wherein, in the second retrieval processing, the at least one processor executes the instructions to retrieve the additional passage from the passage set by using a score obtained by aggregating the first score and the second score for each of the one or plurality of edges.

5. The information processing apparatus according to claim 2, wherein, in the second retrieval processing, the at least one processor executes the instructions to retrieve the additional passage from the passage set with reference to a partial directed graph which is obtained with reference to the initial passage and the association information and forms a part of the directed graph.

6. The information processing apparatus according to claim 1, the at least one processor executes the instructions to further
acquire input data including a sentence group;
generate the passage set including the plurality of passages included in the sentence group; and
calculate the association information including the strength of association between the plurality of passages included in the passage set.

7. The information processing apparatus according to claim 6, wherein, in the calculation of the association information, the at least one processor executes the instructions to calculate the association information by using a language model.

8. An information processing apparatus comprising:
at least one memory configured to store instructions; and
at least one processor configured to execute the instructions to:
acquire input data including a sentence group;
generate a passage set including a plurality of passages included in the sentence group;
calculate, by using a language model, association information which includes a strength of association between the plurality of passages included in the passage set and is referred to in retrieval processing; and
store the association information in association with the plurality of passages.

9. An information processing method comprising:
by at least one processor configured to execute the instructions, the instructions being stored in at least one memory,
acquiring a query;
retrieving an initial passage related to the query from a passage set including a plurality of passages;
retrieving an additional passage from the passage set with reference to association information including a strength of association between the passages included in the passage set, and the initial passage; and
performing retrieval processing using the initial passage and the additional passage.

10. The information processing method according to claim 9, in wherein, in the second retrieval processing, the additional passage is retrieved from the passage set with reference to a directed graph including one or a plurality of edges defined by one or a plurality of passage pairs included in the association information.

11. The information processing method according to claim 10, wherein, in the second retrieval processing, the additional passage is retrieved from the passage set with reference to a first score which indicates a strength of association between a passage pair defining each of the one or plurality of edges and is calculated in advance without referring to the query, and a second score which indicates the strength of association between the passage pair defining each of the one or plurality of edges and is calculated with reference to the query.

12. The information processing method according to claim 11, wherein, in the second retrieval processing, the additional passage is retrieved from the passage set by using a score obtained by aggregating the first score and the second score for each of the one or plurality of edges.

13. The information processing method according to claim 10, wherein, in the second retrieval processing, the additional passage is retrieved from the passage set with reference to a partial directed graph which is obtained with reference to the initial passage and the association information and forms a part of the directed graph.

14. The information processing method according to claim 9, further including:
by the at least one processor executing the instructions,
second acquisition processing of acquiring, by the at least one processor, input data including a sentence group;
generation processing of generating, by the at least one processor, the passage set including the plurality of passages included in the sentence group; and
calculation processing of calculating, by the at least one processor, the association information including the strength of association between the plurality of passages included in the passage set.

15. The information processing method according to claim 14, wherein, in the calculation processing, the at least one processor calculates the association information by using a language model.
